(19) United States
(12) Patent Application Publication
(10) Pub. No.: US 2026/0258771 A1
(43) Pub. Date: Sep. 3, 2026

(54) FLOW DEVICE, INTERNAL COMBUSTION ENGINE, AND METHOD FOR MERGING TWO FLUID FLOWS BY WAY OF SUCH A FLOW DEVICE

(71) Applicant: Rolls-Royce Solutions GmbH, Friedrichshafen (DE)

(72) Inventors: Oliver Hatzing, Ravensburg (DE); Sujit Kadam, Ahmednagar (IN); Rainer Harder, Überlingen (DE)

(73) Assignee: Rolls-Royce Solutions GmbH, Friedrichshafen (DE)

(21) Appl. No.: 19/650,885

(22) Filed: Apr. 17, 2026

Related U.S. Application Data
(63) Continuation of application No. PCT/EP2024/079235, filed on Oct. 16, 2024.

(30) Foreign Application Priority Data
Oct. 17, 2023 (DE) 10 2023 128 466.5
Oct. 16, 2024 (WO) PCT/EP2024/079235

(51) Int. Cl. F02M 21/02

(52) U.S. Cl. CPC F02M 21/0215; F02M 21/0218

(57) ABSTRACT

A flow device includes a flow combining section for merging two fluid flows, including first and second inflow regions for first and second fluid flows, and an outflow region for a combined total fluid flow including the fluid flows, the inflow regions being fluidically connected to the outflow region via supply line sections, supply line cross-sections tapering along flow paths from the inflow regions to the outflow region in a tapering direction, the supply line sections being arranged adjacent to each other in the outflow region along the tapering direction and being separated from each other in a separation section of the outflow region facing the inflow regions by a separating wall oriented transversely to the tapering direction, the separating wall terminating in flow direction upstream of an outflow end, such that the supply line sections are merged in a merging section that is facing away from the inflow regions.

### CROSS REFERENCE TO RELATED APPLICATIONS

This is a continuation of PCT application no. PCT/EP2024/079235, entitled "FLOW DEVICE, INTERNAL COMBUSTION ENGINE AND METHOD FOR MERGING TWO FLUID FLOWS BY MEANS OF A FLOW DEVICE OF THIS TYPE", filed October 16, 2024, which is incorporated herein by reference. PCT application no. PCT/EP2024/079235 claims priority to German patent application no. 10 2023 128 466.5, filed October 17, 2023, which is incorporated herein by reference.

### BACKGROUND OF THE INVENTION

### 1. Field of the Invention

The present invention relates to flow devices.

### 2. Description of the Related Art

IN EP 2 924 271 B1 a homogenizing device for at least two fluid flows is disclosed, wherein turbulences are generated in the fluid flows which are to be merged in order to facilitate mixing. It is therein disadvantageous that the generated turbulences result in a high pressure loss. This also negatively affects the overall efficiency of a system utilizing the two fluid flows, particularly that of an internal combustion engine. Also, uniform flow distribution after mixing is not possible. Moreover, such devices typically require a large installation space.

What is needed in the art is a flow device, an internal combustion engine having such a flow device and a method for merging two fluid flows by way of such a flow device, wherein the aforementioned disadvantages are at least reduced, optionally do not occur at all.

### SUMMARY OF THE INVENTION

The present invention relates to a flow device, to an internal combustion engine having such a flow device and to a method for merging two fluid flows by way of such a flow device.

The present invention provides a flow device which includes a flow combining section which is designed to merge a first fluid flow and a second fluid flow, wherein the flow combining section has a first inflow region for the first fluid flow and a second inflow region for the second fluid flow, as well as an outflow region for the total merged fluid flow consisting of the first and second fluid flow. The first inflow region is fluidically connected with the outflow region via a first supply line section for conducting the flow of the first fluid flow, wherein the second inflow region is fluidically connected with the outflow region via a second supply line section for conducting the flow of the second fluid flow. The first and second supply line sections lead into a common outflow region. A first supply line cross section of the first supply line section tapers along a first flow path from the first inflow region to the outflow region in tapering direction, whereby a second supply line cross section of the second supply line section tapers along a second flow path from the second inflow region to the outflow region, in tapering direction. The first and second supply line sections are arranged adjacent to each other in the outflow region along the tapering direction and are separated from each other in a separation section of the outflow region facing the inflow region by way of a separating wall oriented transversely to the tapering direction. The separating wall terminates in flow direction upstream of – and, in particular, at a finite distance from – an outflow end of the outflow region, so that the supply line sections are merged in a merging section of the outflow region that is facing away from the inflow regions. Advantageously, the two fluid flows to be merged are initially conducted side-by-side or one above the other in the outflow region, however, separated by the separating wall. In the merging section, where the separating wall ends, they flow in the same direction and in a laminar, layered manner, side by side or one on top of the other. The momentum of the flows is directed by the separating wall respectively towards the outlet, which contributes to avoiding turbulences. This results advantageously in a very low pressure loss while maintaining a compact design for the flow combining section and thus for the entire flow device. In particular, the low pressure loss has a positive effect on the efficiency of a system incorporating the flow device, especially an internal combustion engine. Furthermore, it is easily possible to divide the total fluid flow into equal partial flows; that is, with identical composition of the first and second fluid flows in each partial flow. The first and second fluid flows can differ in density and/or volume flow without impairing the functionality of the flow device.

Tapering of the two supply line sections occurs in tapering direction, in particular in opposite direction.

In particular, the first and second supply line sections are designed so that the first and second fluid flow do not experience or acquire any swirling motion within them; in other words, the first and second fluid flows flow laminarly in the respective supply line section. In contrast to the known homogenization device this means that at least reduced, and optionally no, turbulence is generated in the fluid flows that are to be merged.

In one embodiment, the first supply line cross-section tapers constantly or continuously along the first flow path from the first inflow region to the outflow region in tapering direction. Alternatively, or additionally, the second supply cross-section tapers constantly or continuously along the second flow path from the second inflow region to the outflow region in tapering direction.

A further development of the present invention provides that the flow combining section is designed as a Y-tube or Y-pipe. This represents a simple and advantageous arrangement of the flow combining section.

In one embodiment the first supply line section has an S-shape or progresses along an S-curve from the first inflow region to the outflow region. Alternatively, or additionally, the second supply line section has an S-shape or progresses along an S-curve from the second inflow region to the outflow region.

A further development of the present invention provides that a flange is arranged in at least one region, selected from the first inflow region, the second inflow region and the outflow region. It is clearly also advantageously possible to connect the flow combining section with at least one other flow conducting component or flow section in a multi-part configuration. In another arrangement it is also possible that the flow combining section is designed as a single component and/or of a single material with other sections of a flow-conducting structure, so that, for example, at least one of the inflow regions and/or outflow regions forms a section of a single-part conduit, for example, a single-part pipe.

In one arrangement, the first inflow region has a flange, hereinafter also referred to as the first inflow flange. Alternatively, or additionally, the second inflow region has a flange, hereinafter also referred to as the second inflow flange. Alternatively, or additionally, the outflow region has a flange, hereinafter also referred to as the outflow flange. In particular, in one embodiment, the first inflow region, the second inflow region, and the outflow each have a flange.

A further development of the present invention provides that the first supply line cross-section and the second supply line cross-section flatten unilaterally along the respective flow path in the direction of taper on opposite sides along the taper direction, and each forms a flattened side, wherein the first supply line section and the second supply line section are merged in the outflow region in such a way that their flattened sides are in contact with each other, wherein the flattened sides form the separating wall in the separation section of the outflow region. In particular, this causes the two fluid flows to be layered laminarly next to or above each other in the outflow region. The fact that the supply line cross-sections are flattened on one side along the taper direction means, in particular, that the taper caused by the one-sided flattening occurs in the opposite direction in the taper direction; thus, if one of the two supply line cross-sections flattens upwards in the direction of tapering, without limiting the generality, the other of the two supply line cross-sections flattens downwards in the direction of tapering, wherein the flattened areas or flattened sides face each other in the direction of tapering.

A further development of the present invention provides that the first supply line cross section is circular in the first inflow region and semi-circular in the outflow region, whereby the second supply line cross section is circular in the second inflow region and semi-circular in the outflow region, whereby an outflow cross section in the outflow region is circular, whereby the semi-circular first supply line cross section and the semi-circular second supply line cross section together form the circular outflow cross section. This represents an especially advantageous geometry for layering the two fluid flows laminarly side by side or one above the other in the outflow region. In particular, the two semicircular second supply line cross-sections combine to form the circular outflow cross-section. In particular, without limiting the generality, the second semicircular supply line cross-section is designed and arranged rotated by 180° or mirrored on the plane defined by the separating wall relative to the first semicircular supply line cross-section.

A further development of the present invention provides that the centers of the first inflow region, the second inflow region, and the outflow region are in a common plane. Thus, the advantage of this design is that the flow combining section is particularly compact. Specifically, the centers of the first supply line cross-section are located in the first inflow region, those of the second supply line cross-section are located in the second inflow region, and those of the outflow cross-section are located in the common plane. Alternatively, or additionally, the centers of the first inflow flange, the second inflow flange and the outflow flange are located in the common plane.

In one embodiment, the taper direction is perpendicular to the common plane. In particular, this provides an especially compact design of the flow combining section.

Alternatively, or additionally, the first supply line section and the second supply line section are arranged one above the other in the outflow region in a direction perpendicular to the common plane. This ensures in particular, a very compact design of the flow combining section.

A further development of the present invention provides that a flow alignment element is provided in the outflow region. Advantageously, the flow alignment element enhances the laminar alignment of the two fluid flows in the outflow region. The flow alignment element is designed and arranged in particular so that the fluid flows are aligned in flow direction by the flow alignment element. Additionally, the flow alignment element is optionally designed and arranged so that the fluid flows pass through it laminarly. This advantageously avoids turbulence and homogenizes the flow.

The flow alignment element is located in particular in the merging section. In one arrangement, the flow alignment element is located in the outflow flange; it is in particular integrated in the outflow flange. This represents an especially beneficial compact design.

In one arrangement, the flow alignment element is designed as a flow grid. This has the advantage of enabling particularly efficient alignment and, in particular, rectification of the fluid flows.

In one arrangement, the flow alignment element is located immediately behind the separating wall.

A further development of the present invention provides that the flow device has a flow divider section downstream of the outflow region, which is designed to divide the total fluid flow into at least a first partial flow and a second partial flow. Advantageously, the total fluid flow can thus be divided into a plurality of at least two partial flows, in particular with identical proportions of the merged fluid flows, in particular of the merged gases in the partial flows. In one arrangement, the flow divider section is designed to divide the total fluid flow into exactly two partial flows. In another arrangement, it is possible for the flow divider section to be designed to divide the total fluid flow into more than two partial flows.

In one embodiment, the flow divider section is arranged in flow direction immediately downstream of the flow combining section, and in particular is directly fluidically connected with the latter.

A further development of the present invention provides that the flow divider section includes a collecting section and, respectively fluidically connected with the collecting section, a first discharge section for conducting the first partial flow and a second discharge section for conducting the second partial flow. This represents a particularly suitable and compact design of the flow divider section. Advantageously, turbulences are generated in the area where the collecting section leads into the discharge sections, which contributes to effective mixing of the total fluid flow consisting of the merged first and second fluid flows, and in particular to mixing of the respective gases. Additional mixing elements can advantageously be omitted. If the flow divider section is designed to divide the total fluid flow into more than two partial flows, it optionally includes more than two discharge sections for the guidance of the different partial flows which are respectively fluidically connected with the collecting section. The turbulences contributing to mixing are optionally generated only in the total fluid flow and not – as in the known homogenization device – in the individual fluid flows which are to be merged. This produces a significantly reduced pressure loss while simultaneously achieving very effective homogenization.

In one embodiment, the discharge sections are each arranged at an angle other than 180°, in particular an obtuse angle, relative to the collecting section. This means, in particular, that a first principal flow direction determined by the geometry of the collecting section and a second principal flow direction determined by the geometry of one of the discharge sections form an angle other than 180°, in particular an obtuse angle, with each other. In this manner, turbulences are advantageously generated in the region where the collecting section leads into the discharge sections, contributing to particularly effective mixing of the total fluid flow, and especially to particularly thorough mixing of the gases involved.

In one arrangement, the first and second discharge sections have identical cross-sectional areas. This ensures, in particular, that the first and second partial flows have identical proportions of the first and second fluid flows, especially of the respective gases. If more than two discharge sections are provided, optionally all discharge sections have identical cross-sectional areas.

In one embodiment a flange is arranged in at least one area, selected from the collecting section, the first discharge section, and the second discharge section. This makes it advantageously possible to connect the flow divider section to at least one other flow-conducting component or flow section in a multi-part configuration. In another embodiment, however, it is also possible for the flow divider section to be designed as a single unit and/or of the same material as other sections of a flow-conducting structure, so that, for example, at least one of the discharge sections – and/or the collecting section – form subsections of a single-unit conduit, such as a single pipe or the like.

In one arrangement, the collecting section has a flange, which hereinafter is referred to as a collecting flange. Alternatively, or additionally, the first discharge section has a flange, which is also referred to hereinafter as the first discharge flange. Alternatively, or additionally, the second discharge section has a flange, hereinafter also referred to as the second discharge flange. In particular, in one embodiment, the collecting section, the first discharge section, and the second discharge section each have a flange.

In another arrangement, the outflow region and the collecting region are connected with each other via a flange, in particular via the outflow flange and collecting flange. The flow device is optionally designed in two parts, with the flow combining section as a first part and the flow divider section as a second part, wherein the two parts are connected to each other via flanges, in particular the outflow flange and the collecting flange. In particular, the outflow flange and the collecting flange are then attached to each other, in particular bolted together.

In one arrangement, the collecting section and the discharge sections are designed as a single unit, wherein the collecting section at the point where it leads into the discharge section transitions directly into same, in particular, material-homogeneously, wherein the discharge sections have flanges, the discharge flanges, assigned to their ends facing away from the collection section. Optionally, the collecting section also has a flange, the collecting flange, on the inflow side.

If the flow alignment element is arranged in the merging section immediately downstream from the separating wall, it is possible that the first fluid flow and the second fluid flow only come together directly in the collecting section, whereas in contrast, the total fluid flow passing through the flow alignment element is still divided by the flow alignment element – at least to a great extent – into the first fluid flow and the second fluid flow.

In one embodiment, the flow divider section is symmetrical, in particular mirror-symmetrical relative to a mirror plane progressing through the collecting section and separating the two discharge sections. Alternatively, or additionally, the discharge sections are each arranged at identical angles to the collecting section. Optionally, the discharge sections also have identical cross-sectional areas. These features, in particular – both individually and especially in combination – contribute to a uniform distribution of the partial flows with identical proportions of the first and second fluid flows.

A further development of the present invention provides that the flow divider section is designed as a Y-tube or Y-pipe. This represents a simple and advantageous arrangement of the flow divider section.

In one embodiment of the flow device, the flow combining section and the flow divider section are each designed as Y-tube or Y-pipe. In one arrangement, the flow combining section is designed as a Y-pipe rotated relative to the flow divider section, so that the two Y-pipes of the flow combining section and the flow divider section adjoin each other in an imaginary contact area quasi in the region of the respective body of the Y-pipes, with the legs of the Y-pipes extending away from this imaginary contact area.

The present invention also provides an internal combustion engine which includes an inventive flow device or a flow device according to one or several of the previously described embodiments, wherein the flow device is designed to merge two gases.

In connection with the internal combustion engine, the advantages that have already been described in connection with the flow device are particularly evident.

In one embodiment, the flow device is arranged for fixing the two gases.

The flow device is arranged in particular for merging, in particular mixing two fuel gases.

The internal combustion engine can be arranged, for example, to utilize biogas from a biogas-producing plant (in short referred to as biogas-plant) as fuel, whereby biogas production in the biogas plant can fluctuate over time. Therefore, not enough biogas may be available from the biogas plant at the time it is needed for the operation of the internal combustion engine. In this case, it is advantageous if the internal combustion engine is also connected to a natural gas line to supply it with natural gas as its fuel. By way of the flow device, it is now advantageously possible to add natural gas from the natural gas line as a second fluid flow to a first fluid flow of biogas from the biogas plant, in particular depending on a mass flow of biogas currently supplied by the biogas plant.

In one embodiment the flow device is designed to divide the merged gases, in particular the mixture consisting of the two gases, into at least two partial flows, in particular with identical composition, that is, with identical proportions of the combined gases in the partial flows.

The mixture of natural gas and biogas is then optionally divided by the flow device into at least two partial flows having equal proportions and supplied respectively to at least two cylinder banks of the internal combustion engine, so that the cylinder banks of the internal combustion engine can be operated with an identical fuel mixture. The herein proposed flow device is also advantageously capable of handling a single substance, that is, it can easily be operated as a supply line for only one fluid flow to the internal combustion engine, particularly if the other fluid flow is unavailable or fails. Therefore, pure biogas can, for example, be supplied to the internal combustion engine via the flow device, provided that the production in the biogas plant is sufficient; conversely, pure natural gas can be supplied to the internal combustion engine via the flow device if no biogas is being produced by the biogas plant.

In one embodiment, the flow device is located upstream from an air mixer, in particular a Venturi-mixer. Two combustion gases can be advantageously merged, in particular mixed with each other in this manner, before the - possibly divided - total flow, in particular the mixture, is fed to the air mixer and is mixed with combustion air. If the total fluid flow is divided into at least two partial flows, each partial flow is optionally fed to the air mixer that is assigned to the respective partial flow, where it is mixed with the combustion air.

The present invention also provides a method for merging two fluid flows, wherein the two fluid flows are merged into one total fluid flow by way of an flow device according to the present invention, or by way of a flow device according to one or several of the previously described embodiments, in particular by way of a flow combining section of the flow device. In connection with the method, the advantages that have already been described in connection with the flow device or the internal combustion engine are particularly evident.

In one embodiment two gases, in particular two fuel gases, are merged as the two fluid flows, in particular mixed with each other. Alternatively, or additionally, the two fluid flows are merged, in particular mixed, with each other for the operation of an internal combustion engine, in particular during operation of the combustion engine.

A further development of the present invention provides that the total fluid flow is divided by way of the flow device, in particular by way of the flow divider section of the flow device into at least two partial flows. In one embodiment the total fluid flow is divided in such a way that the at least two partial flows have identical compositions.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic representation of a design example of an internal combustion engine with a design example of a flow device;

FIG. 2 is a representation of the design example of flow device according to FIG. 1;

FIG. 3 is a representation of a design example of a flow combining device section of the flow device according to FIGS. 1 and 2;

FIG. 4 are various sectional views of the flow combining device section according to FIG. 3;

FIG. 5 is a first sectional view of the flow device according to FIG. 2;

FIG. 6 is a second sectional view of the flow device according to FIG. 2; and

FIG. 7 is a third sectional view of the flow device according to FIG. 2.

Corresponding reference characters indicate corresponding parts throughout the several views. The exemplifications set out herein illustrate at least one embodiment of the invention, and such exemplifications are not to be construed as limiting the scope of the invention in any manner.

### DETAILED DESCRIPTION OF THE INVENTION

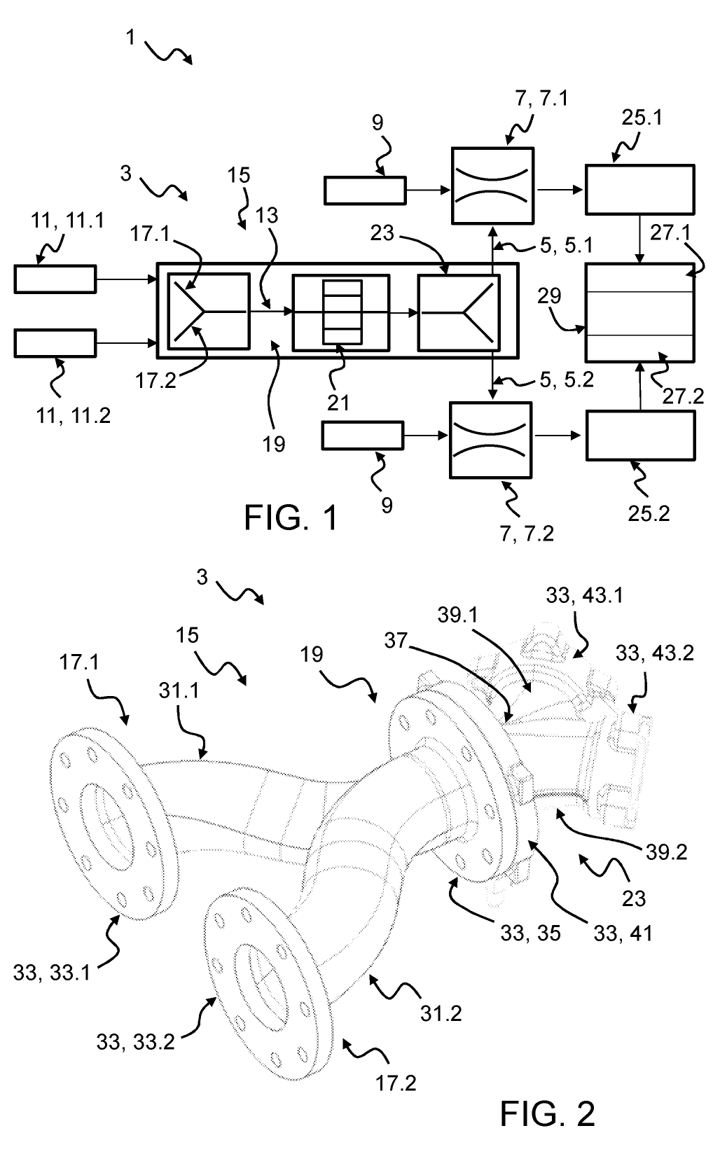

FIG. 1 is a schematic representation of one design example of an internal combustion engine 1 with a design example of a flow device 3, arranged for merging two fluid flows 11 consisting of two gases into one total fluid flow 13. Flow device 3 is designed in particular for mixing the two gases. In the illustrated design example, flow device 3 is designed to mix two fuel gases, for example biogas from a biogas producing plant (biogas for short) and natural gas from a natural gas line.

Flow device 3 is moreover designed to divide total fluid flow 13 of merged gases, in particular the mixture of the two gases, into two partial flows 5 which have an identical composition with respect to the two gases, in other words, equal proportions of the two gases.

Fow device 3 is however also capable of handling a single substance, meaning it can also conduct just one of the gases if the other gas is omitted or unavailable.

Flow device 3 is located upstream from air mixer 7. Partial flows 5 are each fed to an air mixer of air mixers 7 assigned to the respective partial flow of partial flows 5 and mixed there with combustion air 9.

In particular, first fluid flow 11.1 of a first gas of the two fuel gases and second fluid flow 11.2 of a second gas of the two fuel gases are merged, and in particular mixed, to form total fluid flow13 by way of flow device 3. Furthermore, total fluid flow 13 is divided into two partial flows 5 by way of flow device 3.

Flow device 3 has a flow combining section 15, which has a first inflow region 17.1 for first fluid flow 11.1 and a second inflow region 17.2 for second fluid flow 11.2, as well as an outflow region 19 for total fluid flow 13. A flow alignment element 21 is arranged in outflow region 19. Downstream of outflow region 19, flow device 3 includes flow divider section 23 which is designed to divide total fluid flow 13 into partial flows 5, in this example into first partial flow 5.1 and second partial flow 5.2. First partial flow 5.1 is mixed with combustion air in first air mixer 7.1 of air mixers 7, so that a first combustion air-fuel gas mixture 25.1 is created. Second partial flow 5.2 is mixed with combustion air in second air mixer 7.2 of air mixers 7, so that a second combustion air fuel gas mixture 25.2 is created. First combustion air fuel gas mixture 25.1 is supplied to first cylinder bank 27.1 of engine block 29 of internal combustion engine 1; and second combustion air fuel gas mixture 25.2 is supplied to second cylinder bank 27.2 of engine block 29.

FIG. 2 is a representation of the design example of flow device 3 according to FIG. 1.

Same and functionally equivalent elements are provided with the same reference symbols in all figures, so that reference is made to the preceding description in each case.

First inflow region 17.1 is fluidically connected with outflow region 19 via first supply line section 31.1 for conducting first fluid flow 11.1, and second inflow region 17.2 is fluidically connected with outflow region 19 via second supply line section 31.2 for conducting second fluid flow 11.2. First supply line section 31.1 and second supply line section 31.2 lead into common outflow region 19.

In the herein illustrated design example, flow combining section 15 is designed as a Y-tube or Y-pipe. First supply line section 31.1 is S-shaped or progresses along an S-curve from first inflow region 17.1 to outflow region 19. Accordingly, second supply line section 31.2 is also S-shaped or progresses along an S-curve from second inflow region 17.2 to outflow region 19.

First inflow region 17.1 also includes a flange 33 which hereinafter is referred to as first inflow flange 33.1. Second inflow region 17.2 includes a flange 33 which hereinafter is referred to as second inflow flange 33.2. Outflow region 19 includes a flange 33 which hereinafter is also referred to as outflow flange 35.

Flow divider section 23 which is designed as Y-tube or Y-pipe includes a collecting section 37 and, respectively fluidically connected with collecting section 37 includes a first discharge section 39.1 for conducting first partial flow 5.1 and a second discharge section 39.2 for conducting second partial flow 5.2. In particular, turbulences are generated in the area where collecting section 37 leads into discharge sections 39.1 and 39.2, which contribute to effective mixing of total fluid flow 13.

Discharge sections 39.1, 39.2 are arranged at an angle other than 180°, in particular an obtuse angle relative to collecting section 37.

First discharge section 39.1 and second discharge section 39.2 have optionally identical cross-sectional areas. This ensures, in particular, that first partial flow 5.1 and second partial flow 5.2 have identical proportions of first and second fluid flows 11.2, 11.2, that is of the respective gases.

In the herein illustrated design example, collecting section 37 includes a flange 33 which hereinafter is also referred to as collecting flange 41. First discharge section 39.1 includes a flange 33 which hereinafter is also referred to as first discharge flange 43.1 and second discharge section 39.2 includes a flange 33 which hereinafter is also referred to as second discharge flange 43.2.

In particular, outflow region 19 and collecting section 37 are connected with each other via outflow flange 35 and collecting flange 41.

Collecting section 37 and discharge sections 39.1, 39.2 are designed as a single unit, and at a point where collecting section 37 leads into discharge sections 39.1, 39.2, transitions directly into same, optionally material-homogeneously.

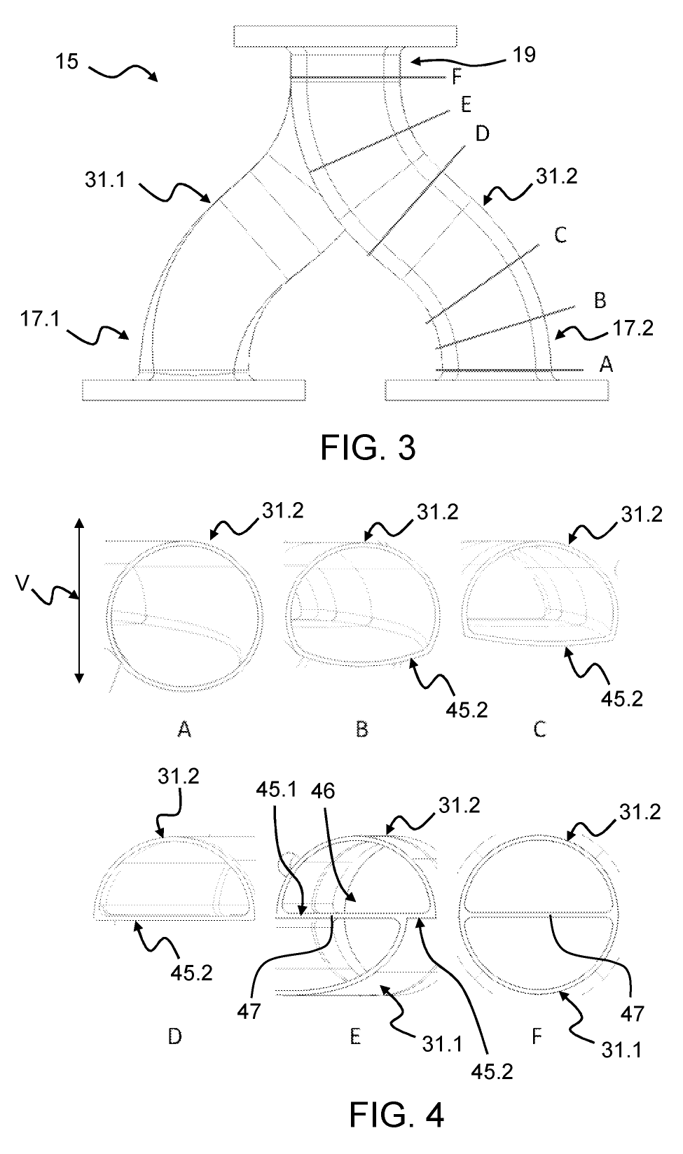

FIG. 3 is a top view onto flow combining section 15 according to FIG. 2. First supply line section 31.1 extends along a first flow path from first inflow region 17.1 to outflow region 19. In FIG. 3, various successive sectional planes along a second flow path from second inflow region 17.2 to outflow region 19 are labelled A to F, with the corresponding sectional views shown in FIG. 4.

FIG. 4 shows different sectional views according to sectional planes A to F in FIG. 3.

Based on these sectional views – which are shown only as examples for second supply line section 31.2, whereby however first supply line section 31.1 develops along the first flow path quasi in a complementary or opposite direction – it becomes clear that a first supply line cross-section of first supply line section 31.1 and a second supply line cross-section of second supply line section 31.2 flatten on one side along the respective flow path in a tapering direction V on sides opposite the tapering direction V and each form a flattened side 45.1, 45.2, wherein first supply line section 31.1 and second supply section 31.2 are merged in outflow region 19 in such a way that they contact each other with flattened sides 45.1, 45.2. Flattened sides 45.1, 45.2 form a partition wall 47 in a separation section 46 of the outflow region facing the inflow areas 17.1, 17.2. Flattened sides 45.1, 45.2 face each other in the direction of narrowing. Fluid flows 11.1, 11.2 are thus layered quasi-laminarly on top of each other in outflow region 19. The first supply line cross-section and the second supply line cross-section optionally taper continuously or steadily along their respective flow paths in the direction of tapering V.

The first supply line cross section and the second supply line cross section are circular in respectively assigned inflow region 17.1, 17.2 and semi-circular in outflow region 19 – compare sectional views A and F. One outflow cross section in outflow region 19 is circular, wherein the semi-circular first supply line cross section and the semi-circular second supply line cross section together form the circular outflow cross section – see sectional view F.

The centers of first inflow region 17.1, second inflow region 17.2, and outflow region 19 are optionally in a common plane, wherein taper direction V is perpendicular to the common plane. Accordingly, first supply line section 31.1 and second supply line section 31.2 are arranged one above the other in outflow region 19 in a direction perpendicular to the common plane – namely in taper direction V.

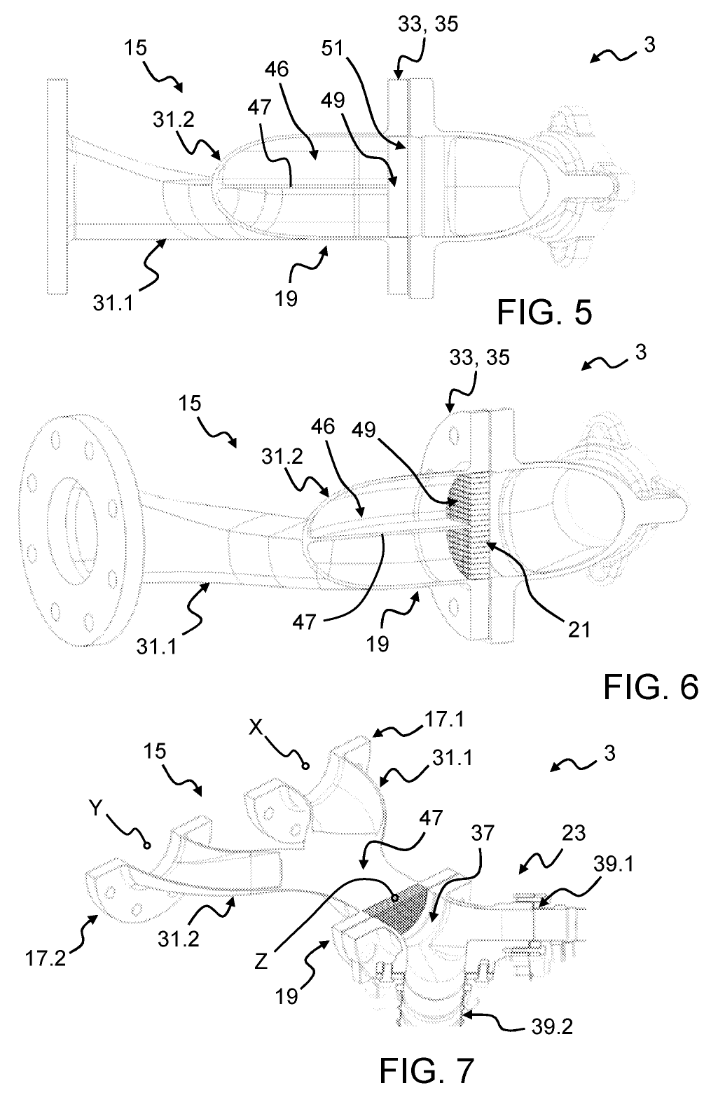

FIG. 5 is a first sectional view of flow device 3, according to FIG. 2

The two fluid flows 11.1, 11.2 to be merged are initially directed side-by-side or one above the other in outflow region 19, however, separated by separating wall 47. In merging section 49 upstream of outflow end 51 of outflow region 19, where partition wall 47 ends, they then flow in the same direction layered quasi on top of each other.

FIG. 6 shows a second sectional view of flow device 3, according to FIG. 2.

Flow alignment element 21, which is designed here as a flow grid, which reinforces the laminar alignment of fluid flows 11.1, 11.2 even downstream of outflow region 19, is arranged in merging section 49 of outflow region 19. In particular, fluid flows 11.1, 11.2 are aligned in flow direction by flow alignment element 21, wherein flow alignment element 21 is optionally subject to laminar flow.

In particular, flow alignment element 21 is arranged in outflow flange 35, in particular integrated in the latter.

FIG. 7 shows a third sectional view of flow device 3, according to FIG. 2.

This illustration clearly shows again that the supply line cross-sections taper in opposite directions, with second fluid flow 11.2 in second supply line section 31.2 being directed upward across the cross-sectional plane of FIG. 7, while first fluid flow 11.1 in first supply line section 31.1 is directed downward below the cross-sectional plane. Moreover, FIG. 7 shows that the two discharge sections 39.1, 39.2 discharging from collecting section 37 have identical cross-sectional areas.

Furthermore, it is shown here that a first center point X of first inflow region 17.1, a second center point Y of second inflow region 17.2, and a third center point Z of outflow region 19 are in the common plane, namely in the section plane of FIG. 7.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A flow device, comprising:
a flow combining section configure for merging a first fluid flow and a second fluid flow, the flow combining section including:
a first inflow region for the first fluid flow;
a second inflow region for the second fluid flow;
an outflow region for a combined total fluid flow including the first fluid flow and the second fluid flow, the outflow region being a common outflow region, the outflow region including a separation section, an outflow end, and a merging section;
a first supply line section, the first inflow region being fluidically connected with the outflow region via the first supply line section, which is configured for conducting a flow of the first fluid flow, the first supply line section including a first supply line cross-section that tapers along a first flow path from the first inflow region to the outflow region in a tapering direction;
a second supply line section, the second inflow region being fluidically connected with the outflow region via the second supply line section, which is configured for conducting the flow of the second fluid flow, the first supply line section and the second supply line section leading into the common outflow region, the second supply line section including a second supply line cross-section that tapers along a second flow path from the second inflow region to the outflow region in the tapering direction;
a separating wall, the first supply line section and the second supply line section being arranged adjacent to each other in the outflow region along the tapering direction and being separated from each other in the separation section of the outflow region facing the first inflow region and the second inflow region by way of the separating wall, which is oriented transversely to the tapering direction, the separating wall terminating in a flow direction upstream of the outflow end of the outflow region , such that the first supply line section and the second supply line section are merged in the merging section of the outflow region that is facing away from the first inflow region and the second inflow region.

2. The flow device according to claim 1, wherein the flow combining section is configured as a Y-tube or a Y-pipe.

3. The flow device according to claim 1, wherein the flow device includes a flange, which is arranged in at least one of the first inflow region, the second inflow region, and the outflow region.

4. The flow device according claim 1, wherein:
the first supply line cross-section includes a first side and the second supply line cross-section includes a second side which opposes the first side, wherein the first supply line cross-section flattens unilaterally along the first flow path in the tapering direction on the first side along the tapering direction and thereby forms a flattened first side, wherein the second supply line cross-section flattens unilaterally along the second flow path in the tapering direction on the second side along the tapering direction and thereby forms a flattened second side, and
the first supply line section and the second supply line section are merged in the outflow region such that the flattened first side and the flattened second side are in contact with each other, wherein the flattened first side and the flattened second side form the separating wall in the outflow region.

5. The flow device according to claim 4, wherein:
the first supply line cross-section is circular in the first inflow region and thereby forms a circular first supply line cross-section, and the first supply line cross-section is semi-circular in the outflow region and thereby forms a semi-circular first supply line cross-section,
the second supply line cross-section is circular in the second inflow region and thereby forms a circular second supply line cross-section, and the second supply line cross-section is semi-circular in the outflow region and thereby forms a semi-circular second supply line cross-section,
the outflow region includes an outflow cross-section which is circular and thereby forms a circular outflow cross-section, and
the semi-circular first supply line cross-section and the semi-circular second supply line cross-section together form the circular outflow cross-section.

6. The flow device according to claim 1, wherein the first inflow region includes a first center, the second inflow region includes a second center, and the outflow region includes a third center, the first center, the second center, and the third center being in a common plane, and wherein at least one of:
(a) the tapering direction is perpendicular to the common plane; and
(b) wherein the first supply line section and the second supply line section are arranged one above the other in the outflow region in a direction perpendicular to the common plane.

7. The flow device according to claim 1, wherein the flow device includes a flow alignment element arranged in the outflow region.

8. The flow device according to claim 7, wherein the flow alignment element is a flow grid, which is arranged in a merging section of the outflow region.

9. The flow device according to claim 1, wherein the flow device includes a flow divider section downstream of the outflow region, the flow divider section being configured for dividing the combined total fluid flow into at least a first partial flow and a second partial flow.

10. The flow device according to claim 9, wherein the flow divider section includes a collecting section, a first discharge section fluidically connected with the collecting section, and a second discharge section fluidically connected with the collecting section, the first discharge section being configured for conducting the first partial flow, the second discharge section being configured for conducting the second partial flow.

11. The flow device according to claim 10, wherein first discharge section and the second discharge section have identical cross-sectional areas.

12. The flow device according to claim 9, wherein the flow divider section is configured as a Y-tube or a Y-pipe.

13. The flow device according to claim 1, wherein the separating wall terminates in the flow direction upstream of, and at a finite distance from, the outflow end of the outflow region.

14. An internal combustion engine, comprising:
a flow device configured for merging two gases, the flow device comprising:
a flow combining section configure for merging a first fluid flow and a second fluid flow, the flow combining section including:
a first inflow region for the first fluid flow;
a second inflow region for the second fluid flow;
an outflow region for a combined total fluid flow including the first fluid flow and the second fluid flow, the outflow region being a common outflow region, the outflow region including a separation section, an outflow end, and a merging section;
a first supply line section, the first inflow region being fluidically connected with the outflow region via the first supply line section, which is configured for conducting a flow of the first fluid flow, the first supply line section including a first supply line cross-section that tapers along a first flow path from the first inflow region to the outflow region in a tapering direction;
a second supply line section, the second inflow region being fluidically connected with the outflow region via the second supply line section, which is configured for conducting the flow of the second fluid flow, the first supply line section and the second supply line section leading into the common outflow region, the second supply line section including a second supply line cross-section that tapers along a second flow path from the second inflow region to the outflow region in the tapering direction;
a separating wall, the first supply line section and the second supply line section being arranged adjacent to each other in the outflow region along the tapering direction and being separated from each other in the separation section of the outflow region facing the first inflow region and the second inflow region by way of the separating wall, which is oriented transversely to the tapering direction, the separating wall terminating in a flow direction upstream of the outflow end of the outflow region, such that the first supply line section and the second supply line section are merged in the merging section of the outflow region that is facing away from the first inflow region and the second inflow region.

15. A method for merging two fluid flows, the method comprising the steps of:
merging the two fluid flows into a combined total fluid flow using a flow device, the flow device including:
a flow combining section configured for merging a first fluid flow and a second fluid flow, the flow combining section including:
a first inflow region for the first fluid flow;
a second inflow region for the second fluid flow;
an outflow region for the combined total fluid flow including the first fluid flow and the second fluid flow, the outflow region being a common outflow region, the outflow region including a separation section, an outflow end, and a merging section;
a first supply line section, the first inflow region being fluidically connected with the outflow region via the first supply line section, which is configured for conducting a flow of the first fluid flow, the first supply line section including a first supply line cross-section that tapers along a first flow path from the first inflow region to the outflow region in a tapering direction;
a second supply line section, the second inflow region being fluidically connected with the outflow region via the second supply line section, which is configured for conducting the flow of the second fluid flow, the first supply line section and the second supply line section leading into the common outflow region, the second supply line section including a second supply line cross-section that tapers along a second flow path from the second inflow region to the outflow region in the tapering direction;
a separating wall, the first supply line section and the second supply line section being arranged adjacent to each other in the outflow region along the tapering direction and being separated from each other in the separation section of the outflow region facing the first inflow region and the second inflow region by way of the separating wall, which is oriented transversely to the tapering direction, the separating wall terminating in a flow direction upstream of the outflow end of the outflow region, such that the first supply line section and the second supply line section are merged in the merging section of the outflow region that is facing away from the first inflow region and the second inflow region.

16. The method according to claim 15, wherein the combined total fluid flow is divided into at least two partial flows by way of the flow device.

17. The method according to claim 15, wherein the two fluid flows that are merged are two fuel gases, wherein the two fluid flows are merged for operation of an internal combustion engine.
